(19) United States
(12) Patent Application Publication
(10) Pub. No.: US 2026/0274136 A1
(43) Pub. Date: Sep. 17, 2026

(54) VEHICLE SEAT

(71) Applicant: TOYOTA BOSHOKU KABUSHIKI KAISHA, Aichi-ken (JP)

(72) Inventors: Takehiro KAJIHARA, Aichi-ken (JP); Atsushi KANAI, Aichi-ken (JP)

(73) Assignee: TOYOTA BOSHOKU KABUSHIKI KAISHA, Aichi-ken (JP)

(21) Appl. No.: 19/563,331

(22) Filed: Mar. 11, 2026

(30) Foreign Application Priority Data
Mar. 13, 2025 (JP) 2025-040114

(51) Int. Cl. B60N 2/90; B60N 2/58; B60N 2/64; B60N 2/68

(52) U.S. Cl. CPC B60N 2/90; B60N 2/58; B60N 2/64; B60N 2/68

(57) ABSTRACT

A vehicle seat includes a bracket attached to a seat assembly and provided with a through hole for h9olding wiring. The bracket includes a pair of plate portions folded inward to define a V-shaped cross section, and a hinge portion formed between the pair of the plate portions. Each of the pair of plate portions includes a mounting portion configured to fit with or engage at least one component of the seat assembly. With the hinge serving as a pivot point, the pair of plate portions is movable between a normal posture in which the pair of plate portions is folded inward to define the V-shaped cross section and an open posture in which the pair of plate portions is opened into a substantially flat configuration.

### CROSS-REFERENCE TO RELATED APPLICATION

This application claims priority to Japanese patent application serial number 2025-40114 filed Mar. 13, 2025, the contents of which are incorporated herein by reference in its entirety for all purposes.

### TECHNICAL FIELD

The present disclosure relates to a vehicle seat in which a bracket provided with a through-hole for holding wiring is attached to seat assembly such as a seat frame.

### BACKGROUND

For example, in a vehicle seat disclosed in a prior art document as shown in FIG. 9, a bracket 20A provided with a through-hole 24A for holding wiring is attached to a rear end portion of a seat cushion 4A serving as a seating portion. The seat cushion 4A includes, as its seat assembly, a fabric seat cover 10A that forms the outer surface of the seat, a seat frame 11A that forms a framework of the seat, and a seat pad 12A that elastically supports an occupant. Further, support springs 115A supporting the seat pad 12A are stretched and fixed between a front portion and a rear portion of the seat frame, 11A and rear end portions of the support springs 115A are hooked onto a pipe-shaped rear frame disposed on the rear end side of the seat cushion 4A.

According to the bracket 20A disclosed in the above document is a flat plate-shaped resin member, which has a predetermined width and extends vertically. An upper end portion of the bracket 20A is sewn to and integrated with a rear end portion of the seat cover 10A. A lower end portion of the bracket 20A is bent into a hook shape so as to be engaged with the support spring 115A. When assembling the seat cover 10A, the lower end portion of the bracket 20A is engaged with the support spring 115A, and a clip 41A fixed to wiring is inserted into the through-hole 24A of the bracket 20A.

In the field of vehicle seats, there is a demand to reduce sewing work in order to suppress cost increases. For example, in the above prior art document as shown in FIG. 10, sewing work is reduced by bending an upper portion of a conventional bracket 20A forward so that the bracket 20A can be attached to the seat frame 11A. Accordingly, a bracket 20A having a V-shaped cross section is formed, and a mounting portion for a rear frame is provided on an upper portion of the bracket 20A, thereby allowing the bracket 20A to be attached to the seat frame 11A instead of being sewn to the seat cover.

However, in this type of bracket, it is necessary to accurately form the through-hole for holding wiring in order to ensure excellent wiring mountability. When the bracket has a V-shaped cross section, formation of the through-hole may require more complicated processing than in a flat plate-shaped bracket. For example, when forming the through-hole in a lower portion of the bracket, it is necessary to press upper and lower portions of the bracket while forming the through-hole only in the lower portion. If a through-hole penetrating both upper and lower portions of the V-shaped bracket is formed, an unnecessary through-hole is formed in the upper portion. The present disclosure has been devised in view of these circumstances, and an object of the present disclosure is to accurately form a through-hole for holding wiring in a bracket while suppressing cost increases.

### SUMMARY

An aspect of the present disclosure is a vehicle seat comprising seat components including a seat cover, a seat pad, and a seat frame, wherein a bracket having a through-hole configured to hold wiring is attached to the seat components. The bracket comprises a pair of plate portions folded inward to define a V-shaped cross section, and a hinge portion formed between the pair of plate portions. Each of the pair of plate portions includes a mounting portion configured to fit with or engage at least one of the seat cover, the seat pad, and the seat frame. With the hinge portion serving as a pivot point, the pair of plate portions is movable between a folded posture in which the pair of plate portions is folded inward to define the V-shaped cross section and an open posture in which the pair of plate portions is opened into a substantially flat, plate-like configuration. In this configuration, since the mounting portions provided on the pair of plate portions can be fitted with or engaged with the seat components, sewing with the seat cover is not required. Further, by opening the pair of plate portions into the flat configuration via the hinge portion, the through-hole for holding the wiring can be formed in either one of the plate portions with high dimensional accuracy.

### BRIEF DESCRIPTION OF DRAWINGS

FIG. 1 is a schematic perspective view of a vehicle seat.

FIG. 2 is a schematic exploded perspective view of a seat cushion.

FIG. 3 is a schematic transparent perspective view of a rear end portion of a seat frame.

FIG. 4 is a schematic cross-sectional view of a rear end portion of the seat frame.

FIG. 5 is a schematic perspective view of the bracket in a normal posture.

FIG. 6 is a schematic perspective view of the bracket in an open posture.

FIG. 7 is a schematic partial cross-sectional view of the bracket during formation of a through-hole.

FIG. 8 is a schematic cross-sectional view of a rear end portion of the seat frame showing the bracket during installation.

FIG. 9 is a schematic perspective view of a conventional seat cushion.

FIG. 10 is a schematic perspective view of the conventional seat cushion showing a modified bracket.

### DETAILED DESCRIPTION

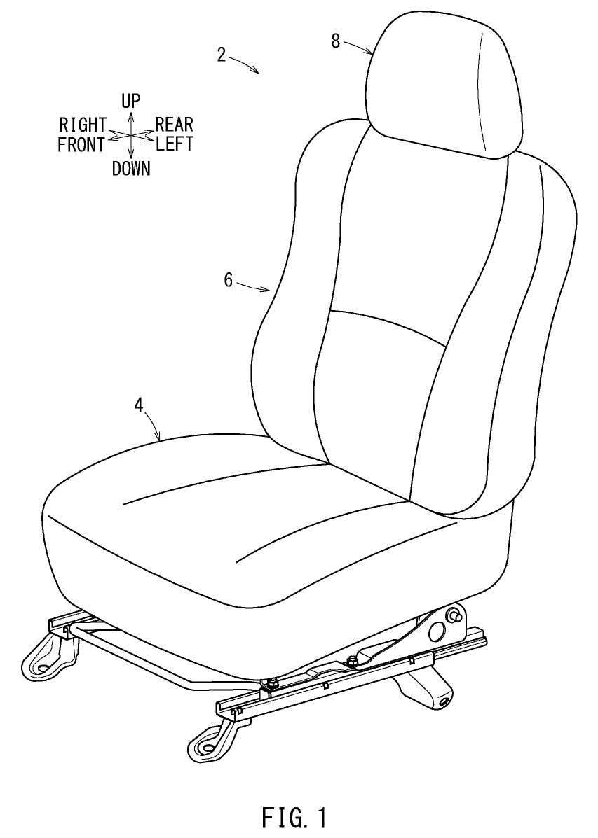

Hereinafter, embodiments of the present disclosure will be described with reference to FIGS. 1 to 8. In the drawings, arrows indicating a front-rear direction, an up-down direction, and a right-left direction of the vehicle seat may be shown as appropriate. In each drawing, main components are illustrated, and other components may be simplified or omitted.

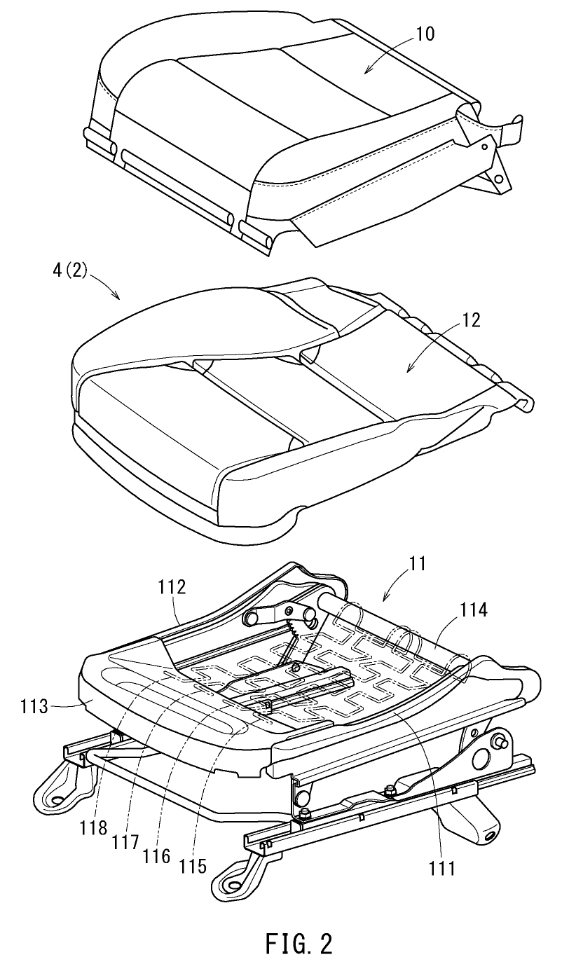

First, an overview of a vehicle seat 2 will be described. As shown in FIG. 1, the vehicle seat 2 includes a seat cushion 4, a seat back 6, and a headrest 8. A lower portion of the seat back 6, which serves as a backrest, is connected to a rear portion of the seat cushion 4, which serves as a seat portion, via a recliner (not shown). The headrest 8 for supporting an occupant’s head is connected to an upper portion of the seat back 6. As shown in FIG. 2, the seat cushion 4 includes a seat cover 10 made of fabric or leather forming an outer surface of the seat, a seat frame 11 forming a framework, and a seat pad 12 elastically supporting an occupant.

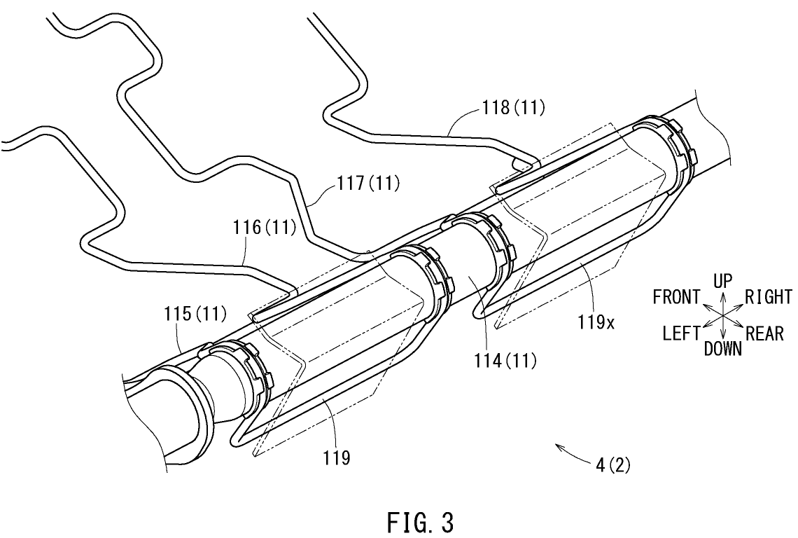

As shown in FIG. 2, the seat frame 11 includes a left side frame 111, a right side frame 112, a front frame 113, a rear frame 114, and support springs 115 to 118 (all mainly made of metal). In FIG. 2, for convenience, the support springs are shown transparently so that other frame portions are visible. The left and right side frames 111 and 112 extend in a front-rear direction of the seat so as to form side framework portions, and are arranged with an appropriate spacing in a seat width direction (right-left direction). The front frame 113 is a plate-shaped member extending in the right-left direction, and is fixed so as to bridge front end portions of the right and left side frames 111 and 112. The rear frame 114 is a pipe-shaped member extending in the right-left direction, and is fixed so as to bridge rear end portions of the right and left side frames 111 and 112. As shown in FIGS. 2 and 3, a plurality of support springs 115 to 118 are mounted so as to be bridged in the front-rear direction between the front frame 113 and the rear frame 114. These support springs 115 to 118 are wire members bent into an S-shape in the right-left direction. As shown in FIG. 3, support springs 115 and 116 (and support springs 117 and 118) arranged side by side in the right-left direction have rear end portions connected to each other by a connecting wire 119 (119x).

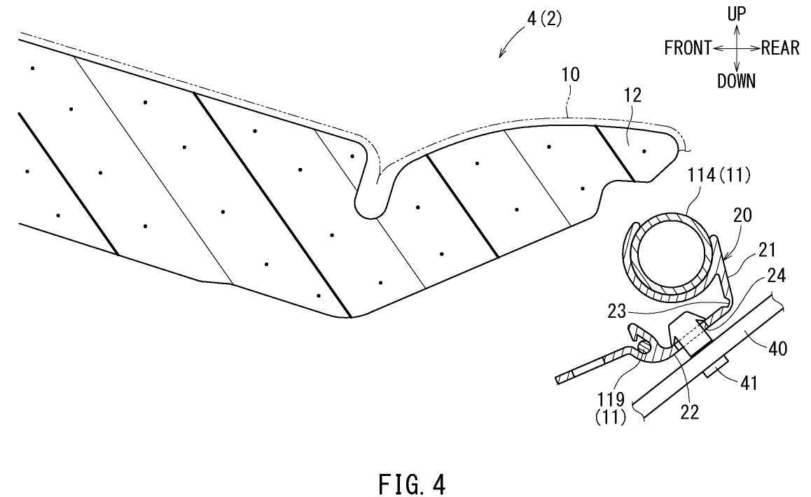

As shown in FIGS. 3 and 4, a plate-shaped bracket 20 may be attached to a rear end portion of the seat cushion 4. The bracket 20 is capable of holding a clip 41 fixed to a wiring 40 via through-holes 24 provided at appropriate positions. In the field of vehicle seats, there is a demand to reduce sewing work in order to suppress cost increases. In addition, from the viewpoint of ensuring excellent mountability of the wiring 40, it is necessary to form the through-holes 24 in the bracket 20 with high accuracy. Accordingly, in the present embodiment, a configuration described later is employed so that the through-holes 24 for holding the wiring 40 are formed in the bracket 20 with high accuracy while suppressing cost increases. Hereinafter, the configuration of the bracket 20 will be described in detail in the order of a first plate portion 21 and a second plate portion 22, a hinge portion 23, the through-holes 24, and a method of forming the bracket 20 and the through-holes 24.

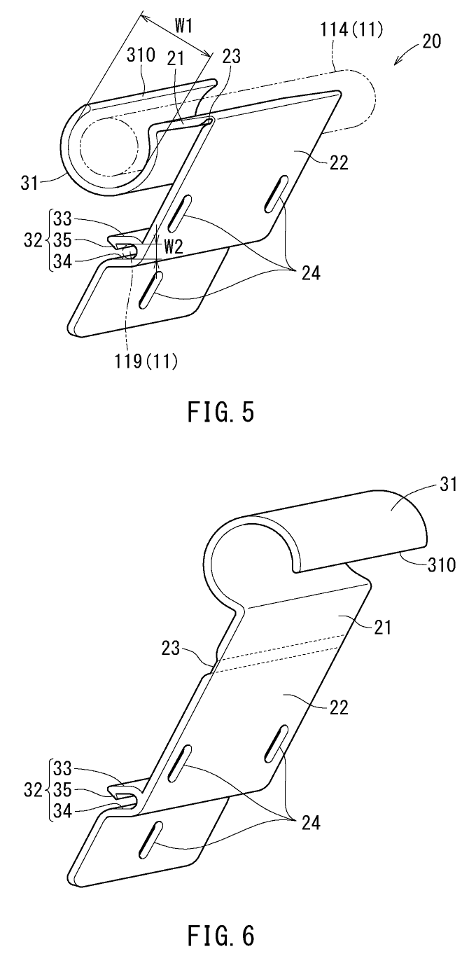

As shown in FIG. 5, the bracket 20 may be mounted to the seat frame 11 in a state where the first plate portion 21 and the second plate portion 22 (a pair of plate portions) are folded inward so as to have a substantially V-shaped cross section (hereinafter referred to as a normal posture). During mounting, the first plate portion 21, which is disposed on an upper side of the seat, is inclined upward gradually toward a front side of the seat. A first mounting portion 31 having an arcuate cross-sectional shape and including an opening 310 opened upward is provided at a distal end (front end) of the first plate portion 21 so as to extend in the seat width direction. Since the first mounting portion 31 has an appropriate inner diameter dimension W1 corresponding to the width of the opening 310, the rear frame 114 inserted through the opening 310 can be fitted therein.

As shown in FIG. 5, the second plate portion 22, which is disposed on a lower side of the seat is inclined downward gradually toward the front side of the seat. The second plate portion 22 is provided with a second mounting portion 32 having a substantially U-shaped cross section and opened toward the front side, the second mounting portion 32 extending in the seat width direction. The second mounting portion 32 is formed by an upper piece 33 and a lower piece 34 protruding from the second plate portion 22. Further, the upper piece 33 is formed with a return piece 35 protruding obliquely toward a rear side and a lower side of the seat. The second mounting portion 32 is configured to have an appropriate opening dimension W2 between the return piece 35 and the lower piece 34 so that the connecting wire 119 (or 119x) can be inserted from the front side, and is also configured such that the return piece 35 can engage with the inserted connecting wire 119 (or 119x).

As shown in FIGS. 5 and 6, the bracket 20 is formed with the hinge portion 23 between the first plate portion 21 and the second plate portion 22. The hinge portion 23 is a thin portion having a smaller thickness than the first plate portion 21 and the second plate portion 22 (an integral hinge), and extends in the seat width direction so as to traverse the bracket 20. With the above-described configuration, the bracket 20 is displaceable, with the hinge portion 23 as a fulcrum, from a normal posture in which the pair of plate portions are folded inward into a V-shaped cross section (the state shown in FIG. 5) to open posture in which the pair of plate portions are opened into a flat plate shape (the state shown in FIG. 6).

As shown in FIG. 5, one or more through-holes 24 for holding the wiring 40 can be formed at appropriate positions in the second plate portion 22 of the bracket 20 (for convenience, all through-holes are denoted by a common reference numeral in each drawing). For example, in the second plate portion 22 of the present embodiment, the through-holes 24 are formed at two specific locations at the left and right end portions above the second mounting portion 32, and at one specific location a distal end (front end) of the second plate portion 22. With the above-described configuration, an appropriate through-hole 24 can be selected from among the plurality of through-holes 24 in accordance with a routing position of the wiring 40, and the clip 41 fixed to the wiring 40 can be inserted into and held by the selected through-hole 24. Further, when the bracket 20 is in the normal posture, the first plate portion 21 in which no through-hole is formed is disposed on an upper side of the seat with respect to at least one of the through-holes 24.

As shown in FIG. 5, the bracket 20 may be formed by producing a main body portion before formation of the through-holes using a method such as extrusion molding or injection molding. By adopting extrusion molding, an increase in manufacturing cost can be suppressed as compared with insert molding that requires a plurality of molds. Further, as shown in FIG. 5, when the bracket 20 is formed as an extruded product, the first mounting portion 31 (and the second mounting portion 32) can be formed with substantially the same inner diameter dimension W1 (opening dimension W2) over the seat width direction.

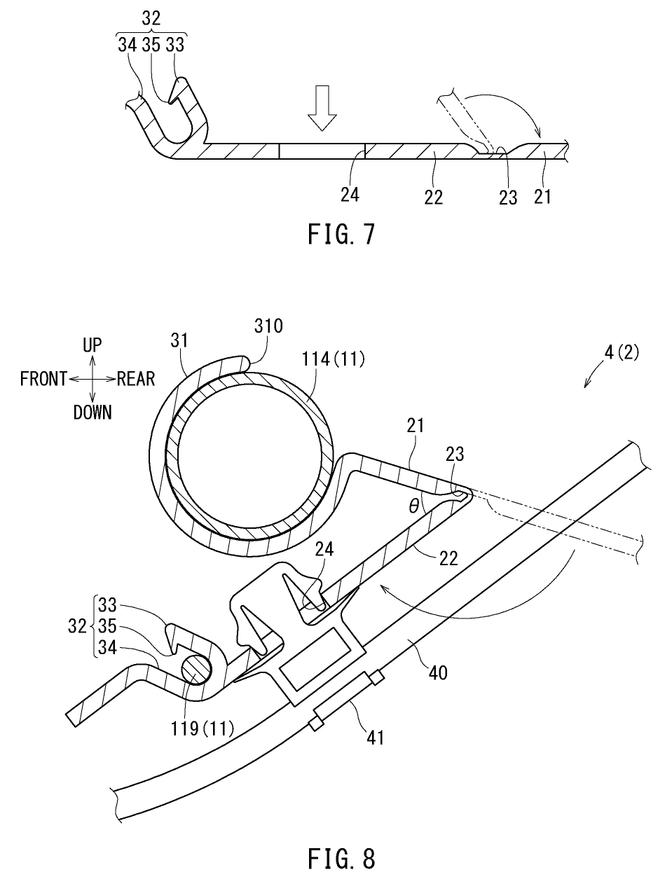

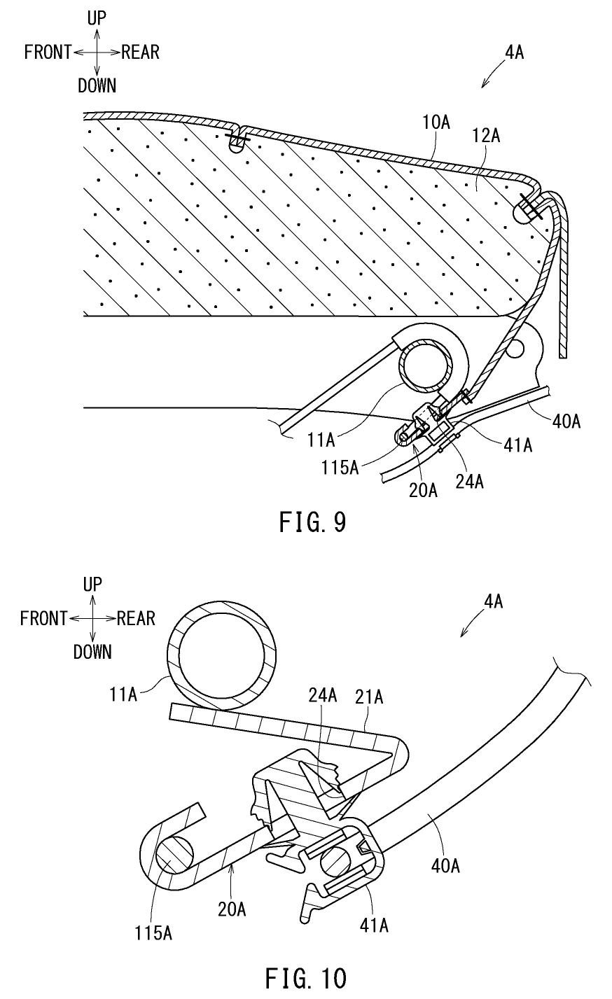

Next, the through-holes 24 are formed at appropriate positions in the second plate portion 22 by a punch mechanism or the like. At this time, it is desirable to form the through-holes 24 in the second plate portion 22 with high accuracy. As shown in FIG. 7, in the present embodiment, the bracket 20 is displaced from the normal posture to the open posture with the hinge portion 23 serving as a fulcrum during formation of the through-holes. In the open posture, the bracket 20 is in a state where the first plate portion 21 and the second plate portion 22 are opened into a flat plate shape. Accordingly, similarly to a conventional flat plate-shaped bracket, the through-holes 24 can be formed in the second plate portion 22 with high accuracy. Therefore, the through-holes 24 can be formed only in the second plate portion 22, and defects such as unnecessary through-holes being formed in the first plate portion 21 can be avoided.

As shown in FIGS. 4 and 8, the bracket 20 is attached to a rear end portion of the seat cushion 4 while being returned to the normal posture. At this time, while adjusting an opening angle θ (see FIG. 8) between the first plate portion 21 and the second plate portion 22, the rear frame 114 is fitted into the first mounting portion 31 of the first plate portion 21. Then, the connecting wire 119 (or 119x) of the support springs is engaged with the second mounting portion 32 of the second plate portion 22. In this manner, the first mounting portion 31 and the second mounting portion 32 of the bracket 20 can be fitted to or engaged with the seat frame 11. Accordingly, sewing with the seat cover 10 becomes unnecessary. In addition, since interference between an end portion of the bracket 20 and the seat cover 10, which may occur due to sewing, does not arise, unintended thread breakage of the seat cover 10 can be suppressed as much as possible. Before or after attachment of the bracket 20, the clips 41 fixed to the wiring 40 are inserted into and held by the respective through-holes 24 of the bracket 20. Since a plurality of through-holes 24 are formed in the bracket 20 with high accuracy, the wiring 40 fixed to the clip 41 can be routed to an appropriate position at the rear end portion of the seat cushion 4 by inserting and holding the clip 41 in any one of the through-holes 24.

Further, as shown in FIGS. 4 and 8, it is possible to improve seat assembly workability by using the bracket 20. That is, the process of installing the bracket 20 and the wiring 40 can be performed independently of the process of installing the seat cover 10. Therefore, the installation process for the bracket 20 and the wiring 40 can be carried out at an appropriate timing from an early stage of the seat assembly process (when the seat is in a frame state) to a final stage. In this manner, by ensuring flexibility in the timing and order of the installation process for the bracket 20 and the wiring 40, seat assembly workability can be improved. For example, by performing the installation process for the bracket 20 and the wiring 40 at an early stage of the seat assembly process, the bracket 20 and the like can be attached to the seat frame 11 with minimal interference from other members. In addition, in seat assembly work, various processes are carried out at different positions of the seat cushion 4. While one worker moves around to a rear side of the seat cushion 4 to perform another process, another worker can simultaneously perform the installation process for the bracket 20 and the wiring 40.

As described above, in the present embodiment, the bracket 20 having a V-shaped cross section is attached to seat constituent members while holding the wiring 40. Since the bracket 20 is configured such that mounting portions provided on each of the first plate portion 21 and the second plate portion 22 can be fitted to or engaged with the seat constituent members, sewing with the seat cover 10 is not required. The first plate portion 21 and the second plate portion 22 are displaceable via the hinge portion 23 to open posture in which they are opened into a flat plate shape. Accordingly, the through-holes 24 can be formed with high accuracy in either the first plate portion 21 or the second plate portion 22 in the flat plate state. Therefore, the through-holes 24 for holding the wiring can be formed in the bracket 20 with high accuracy while suppressing an increase in cost.

Further, in the present embodiment, since the bracket 20 can be attached to the seat frame 11 independently of installation of the seat cover 10, seat assembly workability can be further improved. In addition, in the present embodiment, the bracket 20 can be attached to the seat frame 11 while another process is being performed on a rear end side of the seat cushion 4, thereby further improving seat assembly workability.

The vehicle seat of the present embodiment is not limited to the embodiment described above, and various other embodiments may be adopted. In the present embodiment, the configuration of the bracket has been exemplified; however, the present disclosure is not limited thereto. For example, the first mounting portion may be configured not only to be fitted to a seat constituent member but also to be engaged (including hooked engagement) therewith. Similarly, the second mounting portion may be configured not only to be engaged (including hooked engagement) with a seat constituent member but also to be fitted thereto. The dimensions and shape of the bracket can be appropriately selected according to the seat constituent member to which the bracket is to be attached. One or more through-holes may be provided at appropriate positions in either the first plate portion or the second plate portion. For example, when a through-hole is provided in the first plate portion, the second plate portion in which no through-hole is formed may be disposed on a lower side of the seat relative to the through-hole. The shape and dimensions of the through-hole may also be appropriately selected according to the shape of the clip, and may be formed as an elongated hole, a circular hole, or a polygonal hole.

In the present embodiment, an example in which the bracket is attached to the seat frame has been described. However, the bracket may be attached at an appropriate position of the seat frame, and the attachment position is not necessarily limited to a rear frame. Further, the bracket may be attached by fitting or engaging at least one of the first plate portion and the second plate portion with a seat pad or a seat cover. For example, various wires may be embedded in the seat pad. In such a case, a portion of a wire may be exposed from the seat pad, and the first mounting portion or the second mounting portion may be engaged with the exposed wire. Alternatively, at least one of the first mounting portion and the second mounting portion may be formed to protrude in a hook shape, and such a hook-shaped mounting portion may be inserted into and engaged with a hole formed in the seat cover. The bracket may be disposed at a rear end portion, a front end portion, or left and right side end portions of the seat cushion, and may also be disposed on a seat back side. The posture of the bracket during attachment is determined according to the attachment position, and the first plate portion and the second plate portion may be arranged vertically or horizontally. The configuration of the present embodiment can be applied to vehicle seats in general, such as those for automobiles, aircraft, trains, and ships.

According to another aspect of the present disclosure, a pair of plate portions each has a mounting portion capable of being fitted to or engaged with the seat frame. Accordingly, the bracket can be attached to the seat frame independently of installation of the seat cover, thereby further improving seat assembly workability.

According to another aspect of the present disclosure, the bracket is attached to a rear end portion of a seat cushion serving as a seat portion. Accordingly, when another process is performed on a rear end side of the seat cushion, the bracket can be attached to the seat frame, thereby further improving seat assembly workability.

The various examples described above in detail with reference to the attached drawings are intended to be representative of the present disclosure and are thus non-limiting embodiments. The detailed description is intended to teach a person of skill in the art to make, use and/or practice various aspects of the present teachings, and thus does not limit the scope of the disclosure in any manner. Furthermore, each of the additional features and teachings disclosed above may be applied and/or used separately or with other features and teachings in any combination thereof, to provide an improved vehicle seat, and/or methods of making and using the same.

In the embodiment described above, the wiring 40 is attached to the bracket 20 via the separate clip 41 inserted into the through-hole 24. However, the present disclosure is not limited to this configuration. In another embodiment, the bracket 20 may be configured to hold the wiring 40 directly, thereby eliminating the need for the separate clip 41 and further reducing the number of components and assembly cost.

Specifically, the second plate portion 22 (or the first plate portion 21) may include an integrated wire retaining portion (not shown) that protrudes from a surface of the plate portion. The wire retaining portion is preferably formed integrally with the bracket 20 as a single unitary member. The wire retaining portion may have a substantially C-shaped, U-shaped, or Omega-shaped cross-section defining an internal holding space and an insertion opening. The insertion opening is configured to be slightly narrower than a diameter of the wiring 40. Accordingly, the wiring 40 can be press-fitted through the insertion opening into the holding space utilizing the elasticity of the resin material, whereby the wiring 40 is retained by the bracket 20.

This configuration is particularly advantageous when the bracket 20 is manufactured by extrusion molding. In such a case, the wire retaining portion can be formed as a continuous rail or channel extending along the seat width direction (the direction of extrusion) on the surface of the second plate portion 22. This continuous rail allows the wiring 40 to be held at any position along the width of the bracket 20, providing high flexibility in routing the wiring 40 without requiring the precise positioning of punched holes. Alternatively, portions of the continuous rail may be cut away or removed during a secondary processing step (e.g., simultaneously with the cutting of the bracket to length) to form discrete holding points.

Furthermore, even in this "integrated fastener" embodiment, the hinge portion 23 provides significant manufacturing benefits. For example, if the bracket 20 is formed via injection molding rather than extrusion, the wire retaining portion may require a complex undercut shape (e.g., inward-facing claws to grip the wire). By molding the bracket 20 in the open posture (flat configuration) , the mold dies can access the wire retaining portion more easily compared to molding the bracket in the folded, V-shaped normal posture. Thus, the movable hinge structure contributes to the accurate formation of the integrated wire retaining portion while suppressing mold complexity.

What is claimed is:

1. A vehicle seat, comprising:
a seat assembly including a seat cover, a seat pad, and a seat frame; and
a bracket attached to the seat assembly and having a through-hole configured to hold wiring,
wherein the bracket comprises
a pair of plate portions folded inward to define a V-shaped cross-section; and
a hinge portion connecting the pair of plate portions,
wherein each of the pair of plate portions includes a mounting portion configured to fit with or engage at least one component of the seat assembly, and
wherein, with the hinge portion defining a pivot axis, the pair of plate portions is movable between a folded configuration in which the pair of plate portions are folded inward to define the V-shaped cross-section, and an open configuration in which the pair of plate portions are opened into a substantially flat configuration.

2. The vehicle seat according to claim 1, wherein each of the mounting portions is configured to fit with or engage the seat frame.

3. The vehicle seat according to claim 2, wherein the bracket is attached to a rear end portion of a seat cushion defining a seating portion.

4. The vehicle seat according to claim 1, wherein the hinge portion is an integral hinge having a thickness smaller than a thickness of either of the pair of plate portions.

5. The vehicle seat according to claim 1, wherein the bracket is a resin member formed by extrusion molding.

6. The vehicle seat according to claim 2, wherein the mounting portion of a first one of the pair of plate portions has an arcuate cross-sectional shape defining an upwardly facing opening configured to receive a pipe-shaped rear frame of the seat frame.

7. The vehicle seat according to claim 6, wherein the mounting portion of a second one of the pair of plate portions has a substantially U-shaped cross-section defined by an upper piece and a lower piece protruding from the second plate portion, the U-shaped cross-section opening toward a front side of the vehicle seat.

8. The vehicle seat according to claim 7, wherein the upper piece includes a return piece protruding obliquely toward a rear side and a lower side of the vehicle seat configured to engage a connecting wire of the seat assembly.

9. The vehicle seat according to claim 1, wherein the through-hole is formed exclusively in one of the pair of plate portions, and the other of the pair of plate portions is devoid of through-holes.

10. The vehicle seat according to claim 1, wherein, in the folded configuration: a first one of the pair of plate portions is inclined upward toward a front side of the vehicle seat; and a second one of the pair of plate portions is inclined downward toward the front side of the vehicle seat.
